(19) United States
(12) Patent Application Publication
(10) Pub. No.: US 2002/0093550 A1
(43) Pub. Date: Jul. 18, 2002

(54) Ink jet recording head and ink jet recording apparatus

(76) Inventor: Yasutomo Watanabe, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/025,540

(22) Filed: Dec. 26, 2001

(30) Foreign Application Priority Data
Dec. 28, 2000 (JP) 401120/2000

(51) Int. Cl. B41J 2/05

(52) U.S. Cl. 347/58

(57) ABSTRACT

An ink jet recording head comprises a flat substrate having an end face and front and back flat main surfaces having a larger area as compared to the end face, an energy generating member for generating energy to be utilized to discharge the ink from a discharge port formed on the front flat main surface side of the substrate, a wiring electrode connected to the energy generating member formed on the front flat main surface of the substrate, and a connection electrode, connected to the wiring electrode, for receiving an electrical signal supplied from the outside of the substrate, wherein the connection electrode is provided on another surface different from the front and back flat main surfaces of the substrate. The ink jet recording apparatus comprises the ink jet recording head and a member for mounting the ink jet recording head.

### BACKGROUND OF THE INVENTION

1. Field of the Invention

The present invention relates to an ink jet recording head and an ink jet recording apparatus.

2. Description of the Related Art

Heretofore, ink jet recording technology, particularly bubble jet recording technology has been rapidly popularized, as color printing and personalized printing have advanced in printing in an office. In short, a bubble jet recording head can easily achieve a high density, the structure of many nozzles and the formation of small liquid droplets, and a recording apparatus can extremely easily achieve compaction, a low cost and a high quality, and is characterized by being easily arranged for various applications by simply changing the design of the head, thereby becoming the principal part of the office.

As regards designing with high quality, particularly with high image quality as described above, performance of discharging a liquid droplet in the same direction during discharging an ink droplet exerts a powerful effect on designing with high image quality. That is, in the case where deviation (slippage) in a discharge direction causes an ink to deviate from a position where the ink is to be attached primarily (ideal placement) and the ink is attached to the position before the ink reaches a medium (paper in many cases) to be attached with the ink, since the ink is not fixed on that portion, a portion which is not printed with stripe may be produced.

Since the stripe is easily recognized by a human vision, it is important as a deterioration factor of an image, thereby posing one of important subjects in an ink jet recording. To put it concretely, for example, in the case where a recording head having a discharge amount of 8p1 is used for printing, though it depends on the mode of printing, a deviation of several 10 μm on the medium is sufficiently recognized as the stripe on the medium. The deviation in this discharge direction is determined by the direction the ink droplet is discharged and the distance between the ink discharge port and the medium. That is, closer the discharge direction to the ideal placement, and closer the distance between the ink discharge port and the medium, smaller the deviation.

If the distance between the ink discharge port and the medium is approximately 0 (zero), the deviation will be 0 (zero) regardless of the discharge direction, but it is difficult to reduce the distance for the following reasons.

1. In case the head discharge port comes in contact with the medium, an obstruction may be produced in the head discharge port. Furthermore, the ink having hit the medium scratches thereby to deteriorate the image.

2. Even in the case insomuch that the head discharge port does not contact the medium, as the medium attached with the ink absorbs the ink by bringing the head discharge port close, the ink swells to become uneven (cockling), the distance between the ink discharge port and the medium becomes inconsistent, and in the worst case, such an obstruction as described in point 1) above may be produced. Furthermore, since the head side has a convex portion on the medium side rather than the ink discharge port, it is necessary to expand the distance between the medium and the ink discharge port by the size of the convex portion. The convex portion becomes a sealing material to protect an electric connection electrode from the ink formed on an insulation basic body formed thereon with an ink flow path and an energy generating member for discharging the ink in order to transmit an electrical signal or electric power to the energy generating member. In the case where there is no sealing material, since the ink is an electrolyte in many cases, there may be produced an obstruction which causes a wiring electrode or the electric connection electrode necessary for driving the energy generating member formed on the insulation basic body to corrode or dissolve and the like.

3. Therefore, the sealing material becomes necessary, but the sealing material needs to be approximately 0.2 to 0.6 mm high in the distance of 1 to 2 mm between the ink discharge port and the medium, which in turn exerts an influence on the deviation of ink placement which causes the stripe.

### SUMMARY OF THE INVENTION

An object of the present invention is to provide an ink jet recording head and an ink jet recording apparatus capable of improving the reliability by constituting a sealing material not to be convex.

An ink jet recording head of the present invention comprises a flat substrate having an end face and front and back flat main surfaces having a larger area as compared to the end face, an energy generating member for generating energy to be utilized to discharge the ink from a discharge port formed on the front flat main surface side of the substrate, a wiring electrode connected to the energy generating member formed on the front flat main surface of the substrate, and a connection electrode, connected to the wiring electrode, for receiving an electrical signal supplied from the outside of the substrate, wherein the connection electrode is provided on another surface different from the front and back flat main surfaces of the substrate. Furthermore, the ink jet recording apparatus of the present invention comprises the ink jet recording head and a member for mounting the ink jet recording head.

According to the present invention, it is possible to constitute the sealing material not to be convex, thereby to obtain an effect to improve the reliability of the ink jet recording head.

### BRIEF DESCRIPTION OF THE DRAWINGS

FIG. 1 is a partially sectional view of an ink jet recording head according to a first embodiment of the present invention.

FIG. 2 is a partially sectional view of the ink jet recording head according to a second embodiment of the present invention.

FIG. 3 is a partially sectional view of the ink jet recording head according to a third embodiment of the present invention.

FIG. 4 is a partially broken perspective diagram showing a main portion of an ink jet head according to the embodiment of the present invention.

FIG. 5 is a perspective diagram showing an overall appearance of the ink jet head according to the embodiment of the present invention.

FIG. 6 is a perspective diagram showing an overall appearance of an ink jet recording apparatus according to the embodiment of the present invention.

FIG. 7 is a perspective diagram showing a main portion of the ink jet recording apparatus of the present invention.

### DESCRIPTION OF THE PREFERRED EMBODIMENTS

Embodiments of the present invention will be described hereinafter with reference to the accompanying drawings.

<First Embodiment>

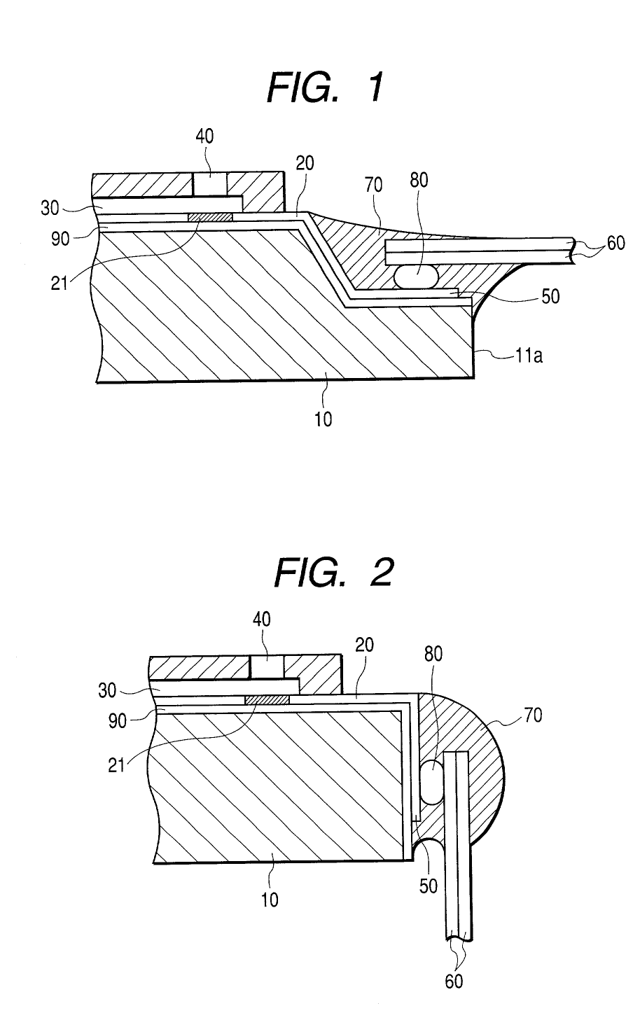

FIG. 1 is a partially sectional view of an ink jet recording head according to a first embodiment of the present invention.

The ink jet recording head according to this embodiment comprises a substrate 10 which is a flat insulation basic body, an energy generating member (heater: electro-thermal conversion body in this embodiment) 21 formed on the substrate 10, a wiring electrode 20 for electrically connecting to the heater, an ink flow path 30 for discharging ink on the heater, an ink chamber, not shown, for supplying the ink to the ink flow path 30, an ink discharge port 40 for determining the discharge direction of ink, a connection electrode 50 for externally supplying an electrical signal or electric power to the wiring electrode 20, an electric wiring substrate (for example, flexible printed circuit board, TAB and the like) 60 electrically connected to the connection electrode 50, and a sealing member 70 for sealing the connected portion of the connection electrode 50 and the electric wiring substrate 60. The substrate 10 has an end face 11a and two main planes of surface and back surface having a larger area as compared to the end face. A step is provided on the substrate 10 formed thereon with the wiring electrode 20 so as to constitute the surface formed with the ink discharge port and the surface arranged with the connection electrode 50 to be separate surfaces. The surface arranged with the connection electrode 50 is the surface parallel to the main plane on the surface side of the substrate.

In this embodiment, Si is selected as the material of the substrate 10 formed with the wiring electrode 20. Now, the method of forming thereof will be described.

An Si substrate used as an insulation substrate 10 is a single crystal Si substrate, and, the surface direction thereof is desirable to be (100). Using the substrate 10, a resist material for etching is first formed into a pattern on the Si substrate in a desired form by a photolithographic process.

Next, a resist pattern is masked, and dipped in etching liquid (such as KOH) for the predetermined time. After etching, the etching liquid is washed, a resist is peeled, and the formed step is coated with an insulation material. As a method for insulation, there is a method for coating an organic insulation material such as polyamide for example, heating and hardening, and a method and the like for forming an inorganic insulation material such as SiO2 by a vacuum film forming method.

Next, the energy generating member is connected on an insulation film 90 and connected to the wiring electrode 20 for supplying the electrical signal, thereby to form a pattern of an electric connection material to be formed into the step. Incidentally, for forming the pattern of the electric connection material, there is a method for vacuum film forming of Al, Cu and the like, and a method and the like for printing a thick film of Au, Pd and the lime, and for patterning, there is a method by screen printing and a method and the like by photolithography.

Next, a bump-like electrode 80 is formed on the connection electrode 50. Forming the bump electrode 80 cannot be necessarily said to be indispensable, but by forming the bump electrode 80, it is desirable to form in a manner to remarkably improve the reliability of connection with the wiring electrode 60 for connecting the electrical signal and the like supplied to the electrode 80. As a method for forming the bump electrode 80, there is a method (stud bonding) for forming by ball bonding from a thin wire of Au or a method and the like for forming by electroforming of Au, Pt and the like.

On this bump electrode 80, the wiring substrate (such as TAB, PPC) 60 formed with a desired pattern is positioned and joined. As a method for joining the wiring substrate 60, there is a method for joining by metal bonding, ACF (anisotropic conductive film), and a method for joining and the like by Ag paste.

After the bump electrode 80 is joined to the wiring substrate 60, the connected portion is sealed with a sealing material 70 in a manner to prevent leaking. Various materials are available as the sealing material 70, but in this case, an epoxy type sealing material with which the reliability can be easily obtained is applied, caused to react and to be hardened by heating. At this point, the convex portion of the sealing material 70 does not fly out from the ink discharge port 40 due to the step formed in a manner as described above, so that there is no influence exerted on the distance between the ink discharge port 40 and the medium.

<Second Embodiment>

Next, a second embodiment of the present invention will be described based on FIG. 2. Further, FIG. 2 is a partially sectional view showing the ink jet recording head of this embodiment.

The ink jet recording head according to this embodiment comprises a substrate 10 which is an insulation basic body and an energy generating member (heater in this embodiment) formed on the substrate 10, a wiring electrode 20 for electrically connecting to the heater, an ink flow path 30 for discharging the ink on the heater, an ink chamber for supplying the ink to the ink flow path 30, an ink discharge port 40 for determining the discharge direction of the ink, a connection electrode 50 for externally supplying an electrical signal or electric power to the wiring electrode 20, an electric wiring substrate (for example, flexible printed circuit board, TAB and the like) 60 electrically connected to the connection electrode 50, and a sealing material 70 for sealing the connected portion of the connection electrode 50 and the wiring substrate 60. A substantially vertical surface (practically 90°) to the substrate 10 forming the wiring electrode 20 is provided, and the connection electrode 50 for connecting the wiring substrate 60 is formed on the vertical end face.

Therefore, the surface forming the ink discharge port 40 and the surface formed with the connection electrode 50 are arranged as separate surfaces.

The substrate 10 used in this embodiment is a single crystal Si substrate having the surface direction of (100), and the method for forming thereof is as described in the first embodiment.

<Third Embodiment>

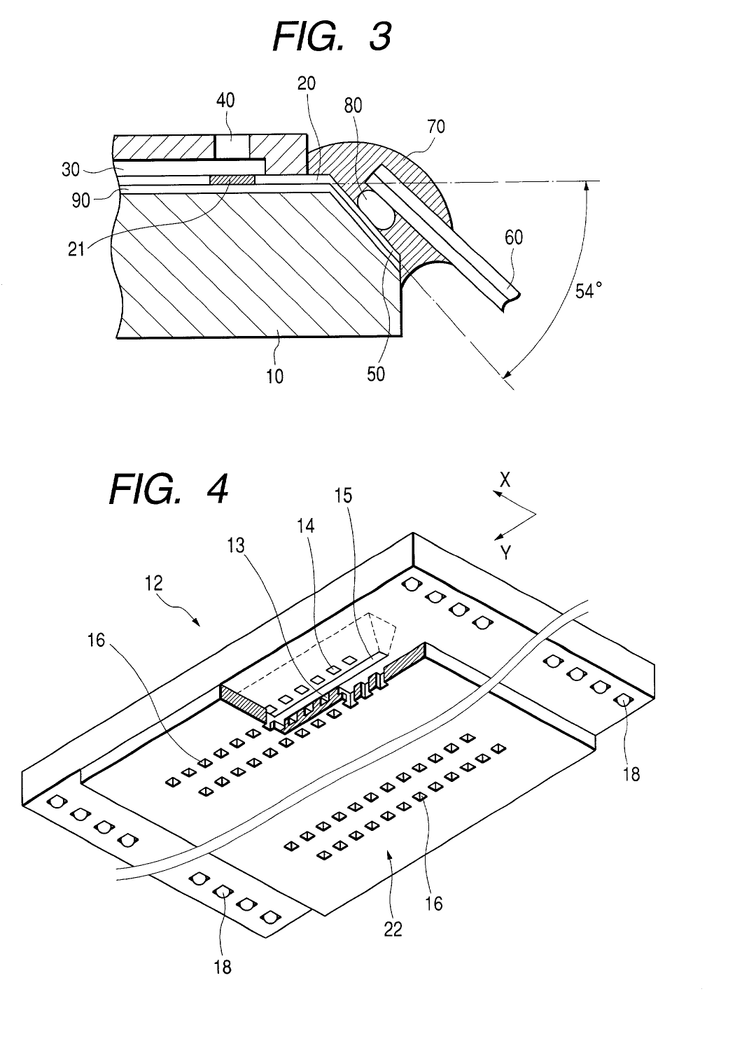

Next, a third embodiment of the present invention will be described based on FIG. 3. Further, FIG. 3 is a partially sectional view showing the ink jet recording head according to this embodiment.

The ink jet recording head according to this embodiment comprises a substrate 10 which is an insulation basic body and an energy generating member (heater in this embodiment) formed on the substrate 10, a wiring electrode 20 for electrically connecting to the heater, an ink flow path 30 for discharging the ink on the heater, an ink chamber for supplying the ink to the ink flow path 30, an ink discharge port 40 for determining the discharge direction of the ink, a connection electrode 50 for externally supplying an electrical signal or electric power to the wiring electrode 20, an electric wiring substrate (for example, flexible printed circuit board, TAB and the like) 60 electrically connected to the connection electrode 50, and a sealing material 70 for sealing the connected portion of the connection electrode 50 and the wiring substrate 60. A surface practically inclined 540 to the substrate 10 forming the wiring electrode 20 is provided, and the connection electrode 50 for connecting the wiring substrate 60 is formed on the surface.

Therefore, the surface forming the ink discharge port 40 and the surface formed with the connection electrode 50 are arranged as separate surfaces.

The substrate 10 used in this embodiment is a single crystal Si substrate having the surface direction of (100), and the method for forming thereof is as described in the first embodiment.

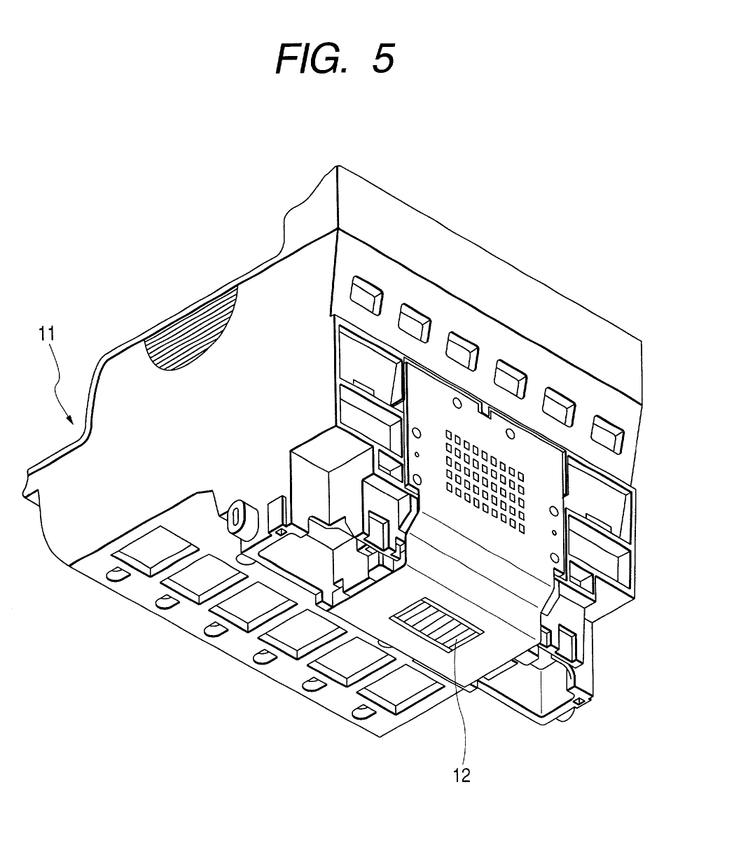

Overall appearance of an ink jet head 11 in the embodiment of the present invention is shown in FIG. 5, and a head chip 12 which is a main portion thereof is shown in FIG. 4 in a broken state. The head chip 12 is produced by using an Si wafer of 0.5 to 1 mm thick for example, long and narrow 6 ink supply ports 15 arranged mutually parallel are formed corresponding to the ink of 6 colors used in this ink jet head 11.

At each ink supply port 15, an ink chamber 13 arranged at a predetermined interval along the longitudinal direction of this ink supply port 15 is formed in 2 lines and disposed so as to sandwich the ink supply port 15, and in each ink chamber 13, an electrothermal converting element 14 and a discharge port 16 for discharging the ink as a droplet opposed to this electrothermal converting element 14 are provided.

In this embodiment, since the mutually parallel 2 lines of the discharge port 16 sandwiching the ink supply port 15 are mutually shifted by a so-called half pitch in a staggered state, and the interval of the ink chamber corresponding to the discharge port 16 of each line is respectively arranged at the pitch of 600 dpi, the interval of the discharge port 16 to be arranged in the longitudinal direction of the ink supply port 15 corresponding to the ink of each color is arranged, in appearance, with a high density of 120 dpi. Furthermore, an electrode wiring 17 formed with the electrothermal converting element 14 and Al and the like for supplying electric power to the electrothermal converting element 14 is formed on the surface of a Si wafer by film forming technology, and the other terminal of the electrode wiring 17 is formed with Au and the like to provide a bump 18 protruding from the surface of the heat generating substrate 12. Not shown in FIG. 4, a peripheral region of the bump 18 has an electrical connecting arrangement as described in FIGS. 1 to 3 in the present invention.

The electrothermal converting element 14 in this embodiment is part of a heat generating resistor layer 19 formed with TaN, TaSiN, Ta—Al and the like for example, not covered by the electrode wiring 17 formed with Al and the like, and has a sheet resistance value of 53Ω. Furthermore, these electrothermal converting element 14 and electrode wiring 17 are covered with a protection layer 20 formed with SiN of 4000 Å thick, furthermore, the surface of the protection layer 20 on the electrothermal converting element 14 is formed with a cavitation resistant layer 21 by Ta of 2300 Å thick.

The ink supply port 15 utilizes the crystal direction of the Si wafer used as the heat generating substrate 12, and is formed by anisotropic etching. That is, in the case where the surface of the Si wafer is <1000> and has the crystal direction of <111> in the direction of the thickness thereof, for example, an alkali type anisotropic etching liquid such as KOH or tetramethyl ammonium hydroxide (TMAH) or hydrazine is used, a selectivity is provided in the etching direction and the surface is etched to a desired depth. Furthermore, the ink chamber 13 and the discharge port 16 are formed by photolithographic technology, and by supplying the electric power to the electrothermal converting element 14, ink droplets of 4 pico liters for example is discharged from the discharge port 16.

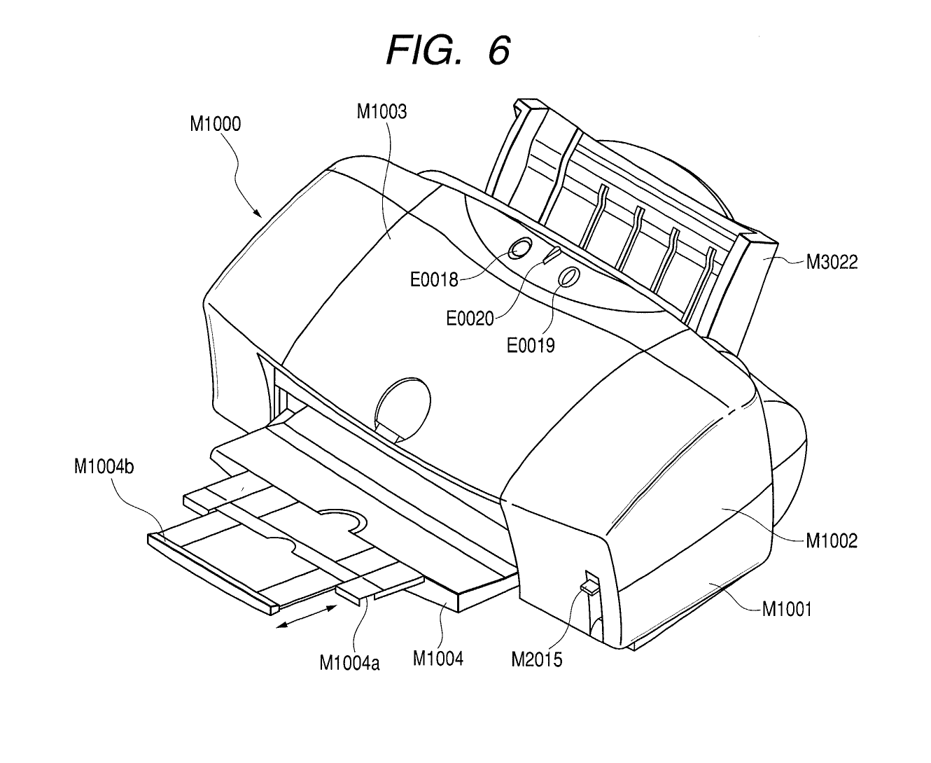

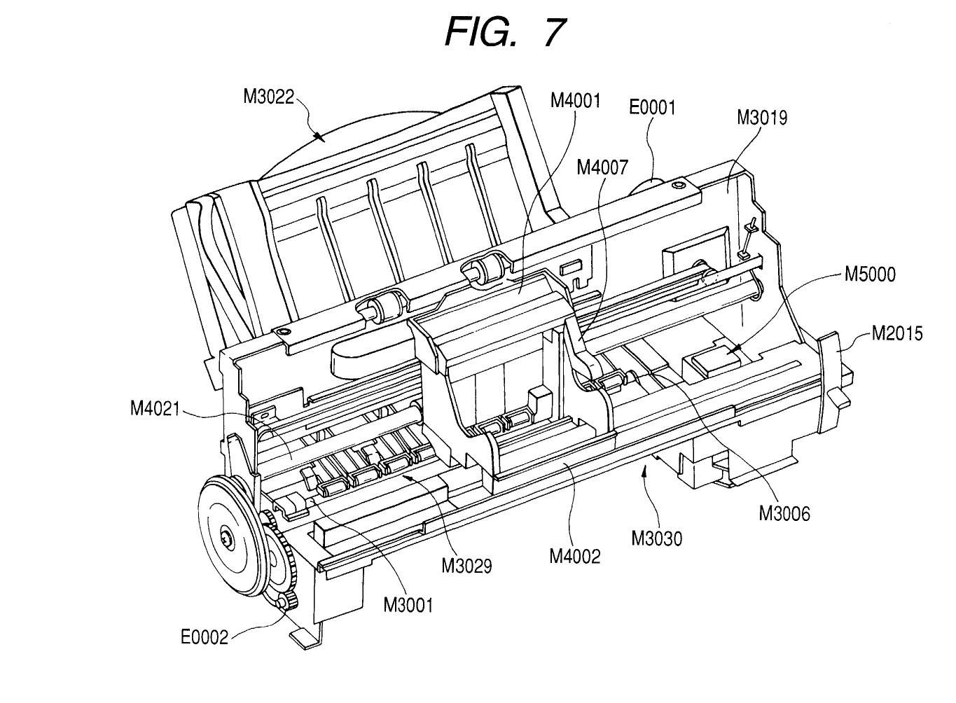

A general constitution of a printer using an ink jet recording system is shown in FIG. 6 and FIG. 7.

In FIG. 6, an apparatus body M1000 constituting a shell of the printer in this embodiment is constituted by an armoring member of a lower case M1001, an upper case M1002, an access cover M1003 and a discharge tray M1004, and a chassis M3019 (refer to FIG. 7) stored in such armoring member.

The chassis M3019 is constituted by a plurality of plate-like metallic members having the predetermined rigidity, forming a framework of a recording apparatus, thereby holding each recording operation mechanism described later.

Furthermore, the lower case M1001 forms the substantially lower half portion of the apparatus body 1000, and the upper case M1002 forms the substantially upper half portion of the apparatus body M1000 respectively, a hollow body structure having a storage space for storing therein each structure described later by combining both cases, and the respective openings are formed on the top and the front thereof.

Furthermore, one end of the discharge tray M1004 is freely rotatably held to the lower case M1001, thereby to open and close the opening formed on the front of the lower case M1001 by the rotation thereof. Therefore, when carrying out the recording operation, by opening the opening by rotating the discharge tray M1004 toward the front, it is possible to discharge a recording sheet therefrom and load the discharged recording sheet P successively. Furthermore, in the discharge tray M1004, two auxiliary trays M1004a, M1004b are stored, and by pulling out each tray toward the operator as occasion demands, it becomes possible to increase and decrease the supporting area of the sheet in 3 stages.

On end of the access cover M1003 is freely rotatably held on the upper case M1002 to allow opening and closing of the opening formed on the top, and by opening this access cover M1003, it becomes possible to replace a recording head cartridge or an ink tank stored inside the body. Furthermore, though not shown here particularly, when the access cover M1003 is opened and closed, a projection formed on the back thereof causes a cover opening and closing lever to rotate, and by detecting the rotating position of the lever, it becomes possible to detect the opening and closing condition of the access cover.

Furthermore, on the top of the rear of the upper case M1002, a power source key E0018 and a resume key E0019 are provided to allow pressing, and LED E0020 is provided, and when the power source key E0018 is pressed, the LED E0020 comes on and informs the operator that recording is possible. Furthermore, the LED E0020, by changing the method of blinking or the color thereof, or by sounding a buzzer E0021, has various display functions such as informing the operator of a trouble and the like of the printer. Furthermore, in the case where the trouble and the like is solved, recording can be restarted by pressing the resume key E0019.

Next, the recording operation mechanism in this embodiment stored and held in the apparatus body M1000 of the printer will be described. As the recording operation mechanism in this embodiment, it is constituted of an automatic feeding portion M3022 for automatically feeding the recording sheet P into the apparatus body, a transfer portion M3029 for leading the recording sheet P sent out one by one from the automatic feeding portion to a desired recording position and leading the recording sheet P from the recording position to a discharge portion M3030, a recording portion for carrying out a desired recording on the recording sheet P transferred to the transfer portion M3029, and a recovery portion (M5000) for carrying out a recovery process to the recording portion and the like. The recording portion is mainly constituted of a carriage M4001 movably supported by a carriage shaft M4021, and a recording head cartridge detachably mounted on this carriage M4001.

What is claimed is:

1. An ink jet recording head comprising:
a flat substrate having an end face and front and back flat main surfaces having a larger area as compared to the end face,
an energy generating member for generating energy to be utilized to discharge the ink from a discharge port formed on the front flat main surface side of the substrate,
a wiring electrode connected to the energy generating member formed on the front flat main surface of the substrate, and
a connection electrode, connected to the wiring electrode, for receiving an electrical signal supplied from the outside of the substrate,
wherein the connection electrode is provided on another surface different from the front and back flat main surfaces of the substrate.

2. The ink jet recording head according to claim 1, wherein the substrate is made of a single crystal Si material; and the surface of the Si material is insulating and the other surface thereof is formed by anisotropic etching.

3. The ink jet recording head according to claim 2, wherein the substrate is thin in a stepwise form in the vicinity of the end face.

4. The ink jet recording head according to claim 3, wherein the other surface is a plane parallel with the front flat main surface of the substrate.

5. The ink jet recording head according to claim 2, wherein the other surface is a plane inclined at an angle of about 54° to the front flat main surface of the substrate.

6. The ink jet recording head according to claim 1, wherein the other surface is a flat end face having an angle of about 90° to the front flat main surface of the substrate.

7. The ink jet recording head according to claim 1, wherein the energy generating member is an electrothermal converting element for generating thermal energy.

8. The ink jet recording head according to claim 1, wherein the discharge port is disposed so as to face the energy generating member.

9. An ink jet recording apparatus comprising:
an ink let recording head having:
a flat substrate having an end face and front and back flat main surfaces having a larger area as compared to the end face,
an energy generating member for generating energy to be utilized to discharge the ink from a discharge port formed on the front flat main surface side of the substrate,
a wiring electrode connected to the energy generating member formed on the front flat main surface of the substrate, and
a connection electrode, connected to the wiring electrode, for receiving an electrical signal supplied from the outside of the substrate, the connection electrode being provided on another surface different from the front and back flat main surfaces of the substrate; and
a member on which the ink jet recording head is mounted.
